(19) United States
(12) Patent Application Publication
(10) Pub. No.: US 2016/0332848 A1
(43) Pub. Date: Nov. 17, 2016

(54) AUTOMATICALLY GUIDED CONTAINER GANTRY LIFTING DEVICE HAVING A MOVABLE SENSOR ASSEMBLY

(71) Applicant: TEREX MHPS IP MANAGEMENT GMBH, Düsseldorf (DE)

(72) Inventors: Armin Wieschemann, Oberhausen (DE); Mohammad Ahmadian, Neuss (DE); Mike Hegewald, Düsseldorf (DE)

(21) Appl. No.: 15/112,621

(22) PCT Filed: Jan. 22, 2015
(86) PCT No.: PCT/EP2015/051269

§ 371 Date: Jul. 19, 2016

(30) Foreign Application Priority Data
Jan. 24, 2014 (DE) 10 2014 100 833.2

(51) Int. Cl. B66C 19/00; B66C 13/18; G05D 1/02

(52) U.S. Cl. CPC B66C 19/007; G05D 1/021; B66C 13/18

(57) ABSTRACT

A gantry lifting device for transferring containers, in particular ISO containers, comprising a sensor assembly for navigating the gantry lifting device and comprising a space for a container transported by the gantry lifting device. The sensor assembly is arranged on the gantry lifting device under the space for the transported container in an operating position and can be moved from the operating position into an idle position, in which the sensor assembly allows the container to be transported to be picked up and/or set down.

### CROSS REFERENCE TO RELATED APPLICATION

The present application claims priority benefits of International Patent Application No. PCT/EP2015/051269, filed on Jan. 22, 2015, and claims benefit of DE 10 2014 100 833.2, which are hereby incorporated herein by reference in their entireties.

### BACKGROUND OF THE INVENTION

The invention relates to a straddle carrier device for handling containers, in particular ISO containers, having a sensor assembly for navigation of the straddle carrier device and having a space for a container transported by the straddle carrier device.

Straddle carrier devices of this type, which are also called straddle carrier stacking wagons, gantry stacking wagons, straddle carriers, van carriers, shuttle carriers or runners, are generally known. They are special handling devices for standardised ISO containers in terminals, in particular port terminals or terminals for combined transport between road and rail. With the aid of a lifting apparatus and a load-receiving means designated as a spreader, straddle carrier devices can lift containers and set them down at a target location after transportation. Since floor-bound straddle carrier devices provided with rubber tires comprise a spider-leg structure they can travel over a container which is resting on the ground or on another container and in so doing additionally also transport a lifted container, depending on construction. In dependence upon the construction height, the straddle carrier devices are designated e.g. as 1 over 3 devices, 1 over 2 devices, etc. A 1 over 3 device can set down a container on 3 stacked containers, pick up one of 3 stacked containers or travel over 3 stacked containers with a picked-up container. In relation to this, ISO containers are understood to be standardised large capacity or sea freight containers which are used in the international transportation of goods. The most widely used are ISO containers with a width of 8 feet and a length of 20, 40 or 45 feet. The straddle carrier device can travel freely and usually has a diesel-electric, a diesel-hydraulic or a fully electric drive. The straddle carrier devices currently in use are predominantly manually controlled, for this purpose a driver's cabin is appropriately provided.

Automatically controlled straddle carrier devices are also known. In European patent EP 2 096 074 B1 a straddle carrier device is described which for navigation purposes uses a combination of satellite navigation and local radio location supported by path measurement. In the region where a container or a container stack is travelled over, laser scanners for automatic steering of the straddle carrier device are additionally used. This type of navigation should be advantageous over so-called transponder or grid point navigation in that no marking elements in the form of transponders or magnets are let into the ground on which the straddle carrier devices travel. The marking elements are, in most cases, passive transponders or magnets. The marking elements are distributed over the surface of the whole port and terminal terrain in the region of the travel paths. This transponder or grid point navigation is also designated as a FROG (Free Ranging On Grid) method. This FROG method is described in more detail in relation to automated, floor-bound, rubber-tired guided vehicles in German patent application DE 10 2006 044 645 A1. In order to navigate the guided vehicle along the marking elements, sensor assemblies in the form of antennas and/or magnetic field sensors are disposed on the guided vehicle. By means of the sensor assemblies, the marking elements let into the travel lane are recognised or read out depending on their design when passed over. For this purpose, the guided vehicles are fitted with wide, flat sensor assemblies which are attached to the front and rear of the guided vehicle just above the ground and in parallel therewith. The sensor assemblies extend transverse to the direction of travel over the whole vehicle width of the guided vehicle and therefore detect more than one marking element at the same time. The information obtained via the sensor assemblies is then used to navigate the vehicle. Since the marking elements are let into the ground in a fixed grid pattern, this navigation method is also designated grid point navigation.

From German laid-open document DE 103 23 641 A1 a forklift truck is known, the sensor of which is moveably disposed on the load-receiving means in the region below the load.

### SUMMARY OF THE INVENTION

The present invention provides an improved driverless straddle carrier device for grid point navigation.

In accordance with an embodiment of the invention, in the case of a straddle carrier device for handling containers, in particular ISO containers, having a sensor assembly for navigation of the straddle carrier device and having a space for a container transported by the straddle carrier device, an improvement is achieved in that the sensor assembly is disposed on the straddle carrier device below the space for the transported container in an operative position and can be moved out of the operative position to an inoperative position in which the sensor assembly allows the container which is to be transported to be picked up and/or set down.

The load operation of the straddle carrier device is not hindered by moving the sensor assembly out of the space below a container to be transported within the straddle carrier device into an inoperative position. Subsequent movement of the sensor assembly into the operative position just above the marking elements let into the ground after picking up or setting down the containers renders it possible to navigate the straddle carrier device automatically by means of grid point navigation.

By means of an aspect of the invention it becomes easily possible also to use automated straddle carrier devices in the integrated network with automated guided vehicles which are already navigated using grid point navigation in the container terminal. This can be achieved by corresponding adaptations on the straddle carrier device and without making changes to the ground of the terminal. The sensor assembly in accordance with the invention alone makes it possible for the straddle carrier devices to be able to travel over containers unhindered despite the vehicle-wide sensor apparatus which is close to the ground. The vehicle-wide sensor assembly in accordance with the invention solves the problem of an otherwise necessary increase in the grid pattern density of marking elements.

In a constructionally simple manner provision is made for the straddle carrier device to comprise a structural clearance which is designed such that the straddle carrier device can travel over a container and the sensor assembly is designed in such a way that the sensor assembly is disposed outside the structural clearance in the inoperative position. The structural clearance surrounds the space required in order to be able to travel with the straddle carrier device in a collision-free manner lengthwise over a container standing on the ground and still to be picked up or already set down, wherein the container is disposed within the structural clearance and passes through the structural clearance.

In an advantageous embodiment, provision is made for the straddle carrier device to be navigated automatically, the sensor assembly to operate according to the principle of grid point navigation and the sensor assembly to be disposed on the straddle carrier device in the operative position in close proximity to ground over which the straddle carrier device travels. A reading distance of 10 to 40 cm with respect to the ground is preferably to be maintained.

In order to be able to use available marking elements which are disposed in a grid pattern and to avoid increasing the grid pattern density of marking elements, provision is made for the sensor assembly to be disposed in the operative position transversely with respect to a direction of travel of the straddle carrier device.

In order that the straddle carrier device can be automatically guided easily in both directions of travel, at least two sensor assemblies are disposed on the straddle carrier device, one sensor assembly of which is disposed at the front of the straddle carrier device and one sensor assembly is disposed at the back of the straddle carrier device as seen in the direction of travel.

Furthermore, provision is advantageously made in constructional terms for the straddle carrier device to have two mutually parallel running gear supports which adjoin the space for a container to be transported and are oriented in the direction of travel of the straddle carrier device, and, in the operative position, the sensor assembly spans the region between the two running gear supports close to the ground.

It is constructionally advantageous for the sensor assembly to be able to pivot from the operative position into the inoperative position about a spindle disposed on the running gear support. In this connection, the possibility exists of a lateral sensor assembly which can pivot in parallel with the ground and of a sensor assembly which can pivot upwards. In a corresponding manner, the spindle is oriented vertically or in the direction of travel and the sensor assembly is oriented vertically or in the longitudinal direction of the running gear supports in the inoperative position. It also results advantageously therefrom that the spindle is oriented vertically or in the direction of travel and the sensor assembly is oriented vertically or in the longitudinal direction of the running gear supports in the inoperative position.

In an advantageous manner, the sensor assembly is divided centrally into two separate parts so that the process of pivoting away or folding away into the inoperative position can be simpler since the sensor assembly as a whole is shorter in each case. The receiving space for the parts of the sensor assembly can then also be selected to be correspondingly smaller.

In an advantageous manner, provision is made for the sensor assembly to be able to be moved in an automatically controlled manner via actuating drives.

Two exemplified embodiments of the invention are described with the aid of the drawings.

### BRIEF DESCRIPTION OF THE DRAWINGS

FIG. 1 shows a first embodiment of a straddle carrier device,

FIG. 2 shows a view of FIG. 1 from below,

FIG. 3 shows a view of FIG. 1 from the side and

FIG. 4 shows a second embodiment of a straddle carrier device.

### DESCRIPTION OF THE PREFERRED EMBODIMENTS

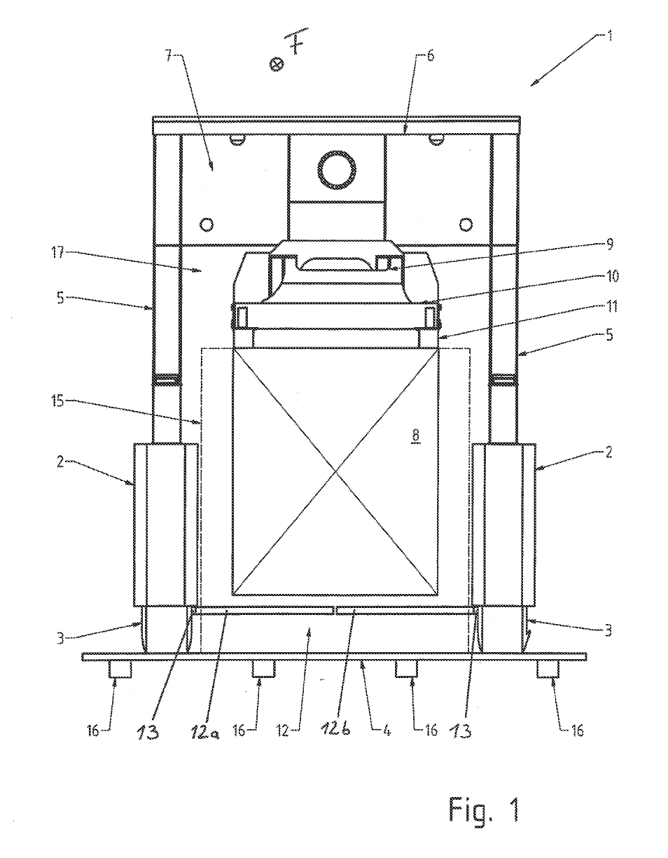

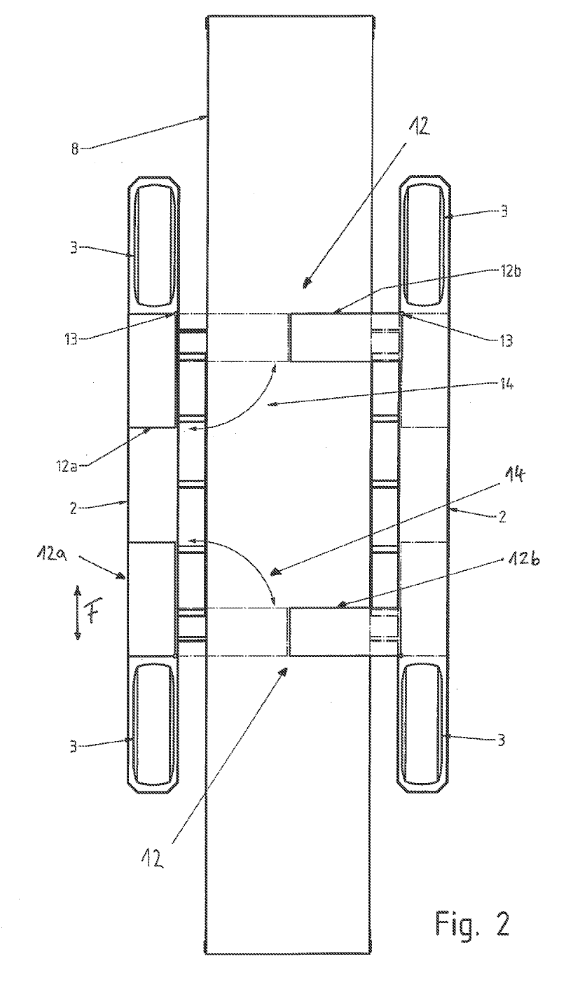

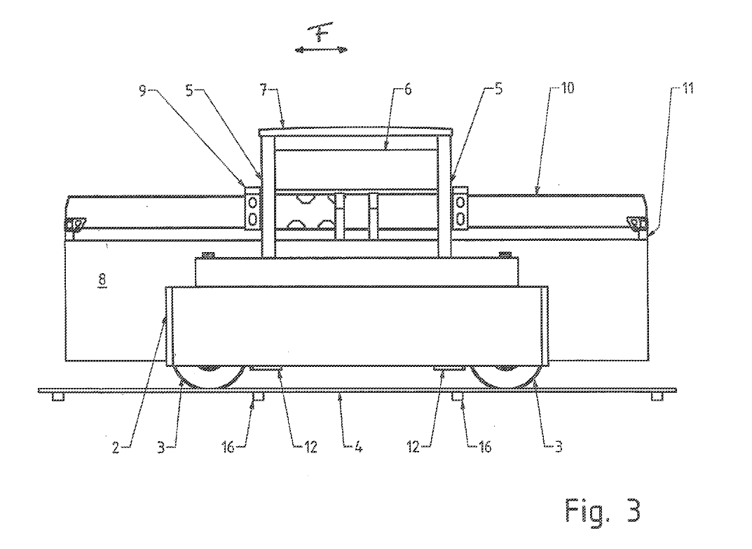

FIG. 1 shows a rough schematic illustration of the principle of the invention by means of a first embodiment applied to a straddle carrier device 1 guided automatically with the aid of grid point navigation in a container handling operation. FIGS. 2 and 3 show views of FIG. 1 from below and from the side. The first embodiment of the straddle carrier device 1 is described herein under with the aid of FIGS. 1 to 3.

The straddle carrier device 1 has two mutually parallel running gear supports 2 oriented in the longitudinal direction of the straddle carrier device 1 and on which steerable wheels 3 are mounted, of which only the front wheels 3 can be seen. The wheels 3, of which two are disposed on one side of the running gear supports 2 in each case, are rubber tired and run on the ground 4 of a container terminal, preferably in a port. The wheels 3 are disposed in a conventional manner at the corners of an imaginary rectangle. It is fundamentally also possible to provide more than four rubber-tired wheels 3 if this is required for technical reasons. However, this is then associated with an increase in the complexity of the straddle carrier device 1 as a whole and therefore more complex technology must be used in the area of driving and steering. In the case of automatically guided straddle carrier devices 1, the navigation also becomes more complex owing to the increase in the number of wheels 3 to be steered. A strut 5 extends from the front and rear of each of the two running gear supports 2, thus a total of four struts 5, extend vertically upwards and form a gantry 7 with a machinery platform 6 positioned thereon and connecting the struts 5. A lifting apparatus 9 for a container 8 is disposed on the machinery platform 6 of the gantry 7, to which lifting apparatus a load picking-up means, designated as a spreader 10, for a container 8 is connected in such a way that it can be raised and lowered. The spreader 10 can be locked to the container 8 at its four corner fittings 11 in order to pick up the load. A space 17 is enclosed by the gantry 7 and the running gear supports 2, in which space a container 8 transported by the straddle carrier device 1 is located after being picked up by the spreader 10 and after being raised by means of the lifting apparatus 9 into a transport position, i.e. still during transportation.

In the lower region of the straddle carrier device 1 a sensor assembly 12 is disposed on the running gear supports 2 and is oriented horizontally or in parallel with the ground 4 and extends with its longitudinal extension transversely with respect to the direction of travel F of the straddle carrier device 1 and approximately over the whole width thereof. The sensor assembly 12 covers at least the width of the space 17 between the two running gear supports 2. This is the case when the container 8 is located in the space 17, i.e. is no longer set down on the ground 4, and the sensor assembly 12 is located below the space 17 in an operative position shown in FIG. 1. In other words, the sensor assembly 12 defines the bottom of the space 17 when the sensor assembly 12 is in the operative position. The sensor assembly 12 is in the operative position even when the straddle carrier device 1 is travelling empty, without a container 8.

In order for the straddle carrier device 1 to be able to pick up and/or set down a container 8, the sensor assembly 12 is moved out of the operative position into an inoperative position in which the sensor assembly 12 allows the movement over the container 8 which is necessary for picking up and/or setting down the container 8 which is to be transported. In FIG. 1, a broken line shows a structural clearance 15 which is to be kept free of the sensor assembly 12 in the inoperative position thereof.

This structural clearance 15 consequently encloses the space which is required to pick up or set down the container 8, preferably lengthwise, by means of the straddle carrier device 1 and, for this purpose, to travel over this container—perpendicularly with respect to the plane of the drawing. Accordingly, the container 8 is disposed within the structural clearance 15 both during picking up, setting down and transportation of the container 8 and passes through same. In the operative position shown in FIG. 1, the sensor assembly 12 cuts the structural clearance 15 below the container 8 suspended on the spreader 10 and thus disposed in the space 17.

The sensor assembly 12 is not a one-piece element but is divided approximately in the middle into two parts 12a, 12b (see also FIG. 2) in order to be able to free the space 17 and in particular the structural clearance 15 for raising, lowing, setting down and picking up containers 8. In this connection, the parts 12a, 12b are each articulated at one of the two ends about a spindle 13 (see also FIG. 2) which is oriented vertically or perpendicular to the ground 4. The parts 12a, 12b can each be pivoted by means of actuating drives, not shown, in each case about the spindles 13 from the horizontal operative position oriented transversely with respect to the direction of travel F of the straddle carrier device 1 into the horizontal inoperative position oriented along the direction of travel F. Hydraulic or electric actuating drives are possible depending on the design of the drive of the straddle carrier device 1. In this connection, the parts 12a, 12b move between the inoperative position and the operative position along a pivoting region 14 which is in the form of a segment of a circle. The direction of travel F of the straddle carrier device 1 extends in parallel with the longitudinal extension of the running gear supports 2.

The sensor assembly 12 contains antennas and/or magnetic field sensors with which marking elements 16 in the form of transponders or magnets disposed in the ground 4 of the container terminal can be detected or read. During travel operation of the straddle carrier device 1 the sensor assembly 12 is pivoted into its horizontal operative position in a region close to the ground so that the sensor assembly 12 can detect the marking elements 16 located thereunder in the ground 4 and the corresponding measurement signals can flow into the automatic navigation of the straddle carrier device 1. Preferably, the space between the sensor assembly 12 and the ground 4 or the marking elements 16 disposed therein amounts to about 10 to 40 cm since a corresponding reading distance to the marking elements 16 disposed in the ground 4 is required. A container 8 transported by the straddle carrier device 1 is thus suspended on the spreader 10 at a distance above the sensor assembly 12 in the space 17.

As shown, the entire region of the ground 4 between the running gear supports 2 is covered by the sensor assembly 12 in the operative position, and therefore almost the entire width of the straddle carrier device 1, so that optimal detection of the marking elements provided is made possible. In a corresponding manner, each sensor assembly 12 with its two parts 12a, 12b intersects the structural clearance 15 in the operative position. In order to be able to lower a container 8 suspended on the spreader 10 so as to set it down and in order to be able to travel over a container 8 standing on the ground 4 and still to be picked up or already set down, the sensor assembly 12 must thus first be moved into the inoperative position in which the sensor assembly 12 is disposed outside the structural clearance 15 and no longer intersects it.

Two sensor assemblies 12 or the respective parts 12a, 12b thereof are preferably housed in flat housings which each have a width smaller than the longitudinal extension. One of the two sensor assemblies 12 is provided in the front region of the straddle carrier device 1 and one sensor assembly 12 is provided in the rear region thereof as seen in the direction of travel F so that forwards and rearwards travel in an equally automated manner is rendered possible (see FIG. 2 and FIG. 3).

FIG. 1 shows the parts 12a, 12b each in the operative position. FIG. 2 shows the pivot region 14, the left parts 12a of the two sensor assemblies 12 in the inoperative position and the right parts 12b of the two sensor assemblies 12 in the operative position. A state during actual operation is not shown.

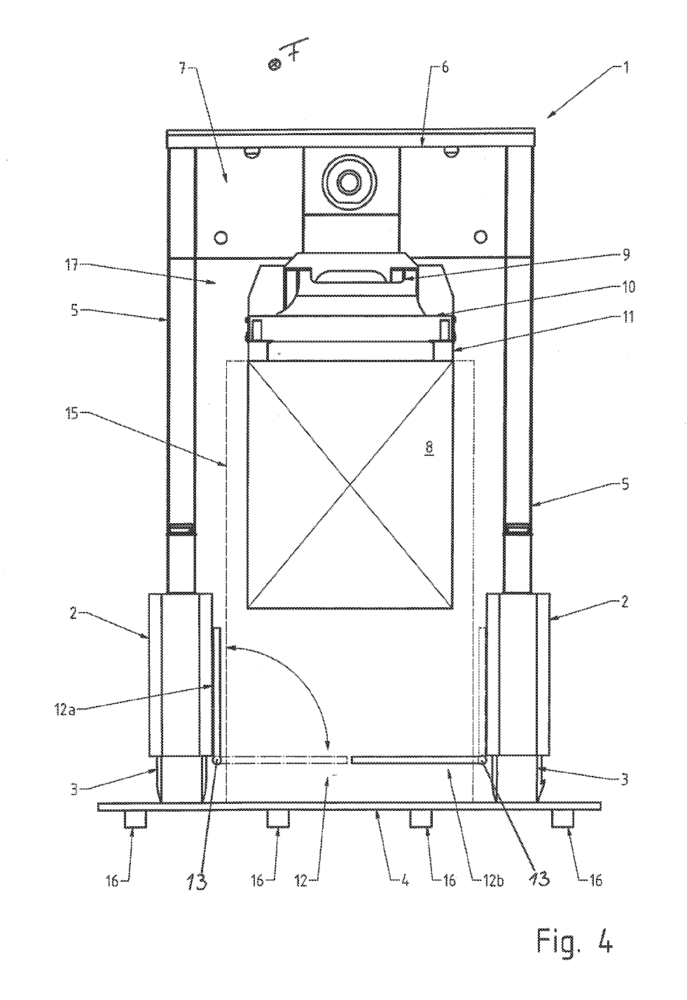

FIG. 4 shows a rough schematic illustration of a second embodiment of a straddle carrier device 1. This straddle carrier device 1 is substantially comparable with the straddle carrier device 1 described above. Thus reference is made to the foregoing description. These two straddle carrier devices 1 differ in the position of the pivot region 14 of the parts 12a, 12b and therefore in the arrangement and orientation of the spindles 13. The left part 12a of the sensor assembly 12 shown in solid lines is illustrated in a vertical inoperative position, while the broken lines indicate the operative position of the part 12a of the sensor assembly 12. Conversely, the second part 12b of the sensor assembly 12 is shown in the operative position on the right in solid lines, while the broken lines indicate the inoperative position of the part 12b. For this purpose, the parts 12a, 12b are each articulated at one of the two ends about a spindle 13 which is oriented horizontally or horizontally with respect to the ground 4 and in the direction of travel F of the straddle carrier device 1. The parts 12a, 12b can each be pivoted by means of actuating drives, not shown, in each case about the spindles 13 out of the horizontal operative position which is oriented transversely with respect to the direction of travel F of the straddle carrier device 1 into the vertical inoperative position which is oriented transversely with respect to the direction of travel F. This illustration serves for the purpose of understanding the function; during travel operation, however, both parts 12a and 12b of the sensor assembly 12 remain in the horizontal operative position; during load operation both parts 12a and 12b of the sensor assembly 12 are in the inoperative position.

The exemplified embodiments show only one possible variation for movement of the sensor assembly 12. Other pivoting, folding or rotating fastenings are possible in order to be able to move the sensor assemblies 12 between the operative position and the inoperative position. Spatially moveable mechanisms can also be provided in order to permit combined movement procedures of the sensor assemblies 12. Naturally, undivided sensor assemblies 12 can also be used, provided that space is available for the inoperative position outside the structural clearance 15.

In order for the straddle carrier device 1 to be automatically controllable and steerable even when the straddle carrier device 1 is travelling over a container 8 which is still to be picked up or has already been set down and the sensor assembly 12 is in the inoperative position for this purpose, the straddle carrier device 1 can be provided with additional sensors e.g. in the form of a laser scanner. By means of these additional sensors, the position of the straddle carrier device 1 in relation to the container 8 can be determined and used for navigation of the straddle carrier device 1 until the travel over the container 8 is so far concluded that the sensor assembly 12 can be moved into the operative position and therefore into the structural clearance 15.

### REFERENCE LIST

1 Straddle carrier device
2 Running gear support
3 Wheels
4 Ground
5 Strut
6 Machinery platform
7 Gantry
8 Container
9 Lifting apparatus
10 Spreader
11 Corner fittings
12 Sensor assembly
12a Part of a sensor assembly
12b Part of a sensor assembly
13 Spindle
14 Pivot path
15 Structural clearance
16 Marking element
17 Space
F Direction of travel

1. A straddle carrier device for handling containers, said straddle carrier device having a sensor assembly for navigation of the straddle carrier device and having a space for a container transported by the straddle carrier device wherein the sensor assembly is disposed on the straddle carrier device below the space for the transported container in an operative position and can be moved out of the operative position to an inoperative position in which the sensor assembly allows the container which is to be transported to be picked up and/or set down.

2. The straddle carrier device as claimed in claim 1, wherein the straddle carrier device comprises a structural clearance which is configured such that the straddle carrier device can travel over a container, and the sensor assembly is configured in such a way that the sensor assembly is disposed outside the structural clearance in the inoperative position.

3. The straddle carrier device as claimed in claim 2, wherein the straddle carrier device is navigated automatically, the sensor assembly operates according to the principle of grid point navigation and the sensor assembly is disposed on the straddle carrier device in the operative position in close proximity to ground over which the straddle carrier device travels.

4. The straddle carrier device as claimed in claim 3, wherein the sensor assembly is disposed in the operative position transverse to a direction of travel of the straddle carrier device.

5. The straddle carrier device as claimed in claim 4, wherein at least two sensor assemblies are disposed on the straddle carrier device, one sensor assembly of which is disposed at the front of the straddle carrier device and one sensor assembly is disposed at the back of the straddle carrier device as seen in the direction of travel.

6. The straddle carrier device as claimed in claim 5, wherein the straddle carrier device has two mutually parallel running gear supports which adjoin the space for a container to be transported and are oriented in the direction of travel of the straddle carrier device, and, in the operative position, the sensor assembly spans the region between the two running gear supports close to the ground.

7. The straddle carrier device as claimed in claim 6, wherein the sensor assembly can pivot from the operative position into the inoperative position about a spindle disposed on the running gear support.

8. The straddle carrier device as claimed in claim 7, wherein the spindle is oriented vertically or in the direction of travel and the sensor assembly is oriented vertically or in the longitudinal direction of the running gear supports in the inoperative position.

9. The straddle carrier device as claimed in claim 8, wherein the sensor assembly is divided centrally into two separate parts.

10. The straddle carrier device as claimed in claim 9, wherein the sensor assembly can be moved in an automatically controlled manner via actuating drives.

11. The straddle carrier device as claimed in claim 1, wherein the straddle carrier device is navigated automatically, the sensor assembly operates according to the principle of grid point navigation and the sensor assembly is disposed on the straddle carrier device in the operative position in close proximity to ground over which the straddle carrier device travels.

12. The straddle carrier device as claimed in claim 1, wherein the sensor assembly is disposed in the operative position transverse to a direction of travel of the straddle carrier device.

13. The straddle carrier device as claimed in claim 2, wherein the sensor assembly is disposed in the operative position transverse to a direction of travel of the straddle carrier device.

14. The straddle carrier device as claimed in claim 1, wherein at least two sensor assemblies are disposed on the straddle carrier device, one sensor assembly of which is disposed at the front of the straddle carrier device and one sensor assembly is disposed at the back of the straddle carrier device as seen in the direction of travel.

15. The straddle carrier device as claimed in claim 2, wherein at least two sensor assemblies are disposed on the straddle carrier device, one sensor assembly of which is disposed at the front of the straddle carrier device and one sensor assembly is disposed at the back of the straddle carrier device as seen in the direction of travel.

16. The straddle carrier device as claimed in claim 1, wherein the straddle carrier device has two mutually parallel running gear supports which adjoin the space for a container to be transported and are oriented in the direction of travel of the straddle carrier device, and, in the operative position, the sensor assembly spans the region between the two running gear supports close to the ground.

17. The straddle carrier device as claimed in claim 16, wherein the sensor assembly can pivot from the operative position into the inoperative position about a spindle disposed on the running gear support.

18. The straddle carrier device as claimed in claim 17, wherein the spindle is oriented vertically or in the direction of travel and the sensor assembly is oriented vertically or in the longitudinal direction of the running gear supports in the inoperative position.

19. The straddle carrier device as claimed in claim 1, wherein the sensor assembly is divided centrally into two separate parts.

20. The straddle carrier device as claimed in claim 1, wherein the sensor assembly can be moved in an automatically controlled manner via actuating drives.
